(19) United States
(12) Patent Application Publication
(10) Pub. No.: US 2017/0264209 A1
(43) Pub. Date: Sep. 14, 2017

(54) Rectifying Module and Generating Device use thereof

(71) Applicant: Eltronix Co., Ltd., Hsinchu City (TW)

(72) Inventor: Chuan-Po Ling, Hsinchu (TW)

(21) Appl. No.: 15/063,689

(22) Filed: Mar. 8, 2016

(51) Int. Cl. H02M 7/06; H02P 9/14

(52) U.S. Cl. CPC H02M 7/06; H02P 9/14

(57) ABSTRACT

A rectifying module including an input end, a load end, a one way conduction element, an electricity storage device, a first switch, and a first control circuit is provided. The one way conduction element is electrically connected between the input end and the load end. The electricity storage device is used to store electricity energy. The first switch is electrically connected between the input end and the electricity storage device. The first control circuit is electrically connected to the output end, and is used to enable the first switch when the voltage of the load end is bigger than a predetermined value. A generating device use thereof is provided.

### BACKGROUND OF THE INVENTION

### Field of the Invention

The invention is related to an generating device, and more particularly to a rectifying module.

### Description of Related Art

Rectifier are used to convert an alternating voltage into a direct-current voltage. Known rectifier is usually do nothing to deal with the exceed working voltage and lead to the chance to damage the load or reduce the life-span of the rectifier. Someone use resistance simply to protect the rectifier from damage or life-span reducing by exceeding voltage. But the exceeding voltage just be transformed to useless heat and dissipated. Moreover, the heat than backs to warm the rectifier and reduces the life span of the rectifier. Some rectifier equips with a large heat sink to resolve the problem of heat, but the excess electric energy still be wasted and occupy a lot of space.

U.S. Pat. No. 9,203,327 discloses a synchronous rectifier including a positive half-bridge, negative half-bridge, controllable switch, and control circuit.

### SUMMARY OF THE INVENTION

The invention provides a rectifying module that could reduce the temperature of the rectifying module.

The invention provides a generating device with a better electric energy utilization rate.

Other objects and advantages of the invention could be further illustrated by the technical features broadly embodied and described as follows.

In order to achieve one or a part of or all of the above advantages or other advantages, an embodiment of the invention provides a rectifying module including an input end, a load end, a one way conduction element, an electricity storage device, a first switch, and a first control circuit. The one way conduction element is electrically connected between the input end and the load end for that the electric charge pass from the input end to the load end when the voltage of the input end is larger than the voltage of the load end. The electricity storage device is used to store electricity energy temporarily. The first switch is electrically connected between the input end and the electricity storage device. The first control circuit is electrically connected to the load end and is used to enable the first switch when the voltage of the load end is larger than a predetermined value.

An embodiment of the invention provides a rectifying module wherein the electricity storage device is a first coil.

An embodiment of the invention provides a rectifying module wherein the magnetic field of the first coil when electrified interacts with a magnetic field of a permanent magnet or a second coil.

An embodiment of the invention provides a rectifying module further including an electric device wherein the electricity storage device is a capacitor, a coil or a battery used to power the electric device.

An embodiment of the invention provides a rectifying module further including a second control circuit used to switch on and off the first switch repeatedly for rectifying.

An embodiment of the invention provides a rectifying module including an input end, a load end, an electricity storage device, a first switch, a second switch, a first control circuit, and a second control circuit. The electricity storage device is used to store electricity energy temporarily. The first switch is electrically connected between the input end and the electricity storage device. The second switch is electrically connected between the input end and the load end. The first control circuit is electrically connected to the load end and is used to enable the first switch when the voltage of the load end is larger than a predetermined value. The second control circuit is used to switch on and off the second switch repeatedly for rectifying.

An embodiment of the invention provides a rectifying module wherein the electricity storage device is a first coil.

An embodiment of the invention provides a rectifying module wherein the magnetic field of the first coil when electrified interacts with a magnetic field of a permanent magnet or a second coil.

An embodiment of the invention provides a rectifying module further including an electric device wherein the electricity storage device is a capacitor, a coil or a battery used to power the electric device.

An embodiment of the invention provides a rectifying module wherein the second control circuit is electrically connected to the first switch to switch on and off the first switch repeatedly for rectifying.

An embodiment of the invention provides a generating device including a generator, a first battery, and a rectifying module. The rectifying module includes an input end, a load end, a one way conduction element, an electricity storage device, a first switch, and a first control circuit. The input end is electrically connected the generator. The load end is electrically connected the first battery. The one way conduction element is electrically connected between the input end and the load end for that the electric charge pass from the input end to the load end when the voltage of the input end is larger than the voltage of the load end. The electricity storage device is used to store electricity energy temporarily. The first switch is electrically connected between the input end and the electricity storage device. The first control circuit is electrically connected to the load end and used to enable the first switch when the voltage of the load end is larger than a predetermined value.

An embodiment of the invention provides a generating device wherein the electricity storage device is a first coil.

An embodiment of the invention provides a generating device wherein the magnetic field of the first coil when electrified interacts with a magnetic field of a permanent magnet or a second coil.

An embodiment of the invention provides a generating device wherein the generator further comprises a stator and a rotor, and a distance between the stator and the rotor is changeable by the magnet field interactive between the first coil and the permanent magnet or the second coil.

An embodiment of the invention provides a generating device wherein the generator further comprises a stator and a rotor, and a distance between the stator and the rotor are able to increase by the magnet field interactive between the first coil and the permanent magnet or the second coil.

An embodiment of the invention provides a generating device further including an electric device. The generator further includes a stator and a rotor wherein the electric device is used to change a distance between the stator and the rotor. The electricity storage device is used to power the electric device.

An embodiment of the invention provides a generating device further including an electric device. The generator further includes a stator and a rotor wherein the electric device is used to increase a distance between the stator and the rotor. The electricity storage device is used to power the electric device.

An embodiment of the invention provides a generating device wherein the electricity storage device is a capacitor, a coil or a battery.

An embodiment of the invention provides a generator device wherein the rectifying module further includes a second control circuit used to switch on and off the first switch repeatedly for rectifying.

An embodiment of the invention provides a generating device including a generator, a first battery, and a rectifying module. The rectifying module includes an input end, a load end, an electricity storage device, a first switch, a second switch, a first control circuit, and a second control circuit. The input end is electrically connected the generator. The load end is electrically connected the first battery. The electricity storage device is used to store electricity energy temporarily. The first switch is electrically connected between the input end and the electricity storage device. The second switch is electrically connected between the input end and the load end. The first control circuit is electrically connected to the load end and used to enable the first switch when the voltage of the load end is larger than a predetermined value. The second control circuit is used to switch on and off the second switch repeatedly for rectifying.

An embodiment of the invention provides a generating device wherein the electricity storage device is a first coil.

An embodiment of the invention provides a generating device wherein the magnetic field of the first coil when electrified interacts with a magnetic field of a permanent magnet or a second coil.

An embodiment of the invention provides a generating device wherein the generator further comprises a stator and a rotor. A distance between the stator and the rotor is changeable by the magnet field interactive between the first coil and the permanent magnet or the second coil.

An embodiment of the invention provides a generating device wherein the generator further comprises a stator and a rotor. A distance between the stator and the rotor is able to increase by the magnet field interactive between the first coil and the permanent magnet or the second coil.

An embodiment of the invention provides a generating device further including an electric device. The generator further includes a stator and a rotor. The electric device is used to change a distance between the stator and the rotor. The electricity storage device is used to power the electric device.

An embodiment of the invention provides a generating device further including an electric device. The generator further includes a stator and a rotor. The electric device is used to increase a distance between the stator and the rotor. The electricity storage device is used to power the electric device.

An embodiment of the invention provides a generating device wherein the electricity storage device is a capacitor, a coil or a battery.

An embodiment of the invention provides a generator device wherein the second control circuit is electrically connected to the first switch to switch on and off the first switch repeatedly for rectifying.

Based on the above, the rectifying module and the generating device of the embodiment of the invention has at least one of the following advantages. In the rectifying module according to the embodiment of the invention, the first control circuit is electrically connected to the load end and used to enable the first switch when the voltage of the load end is larger than a predetermined value. The excess electric energy could be transmitted to the electricity storage device for other utilization. The electric energy utilization rate is better, the waste heat of the rectifying module is reduced, and the durable of the rectifying module is better.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic of a rectifying module according to an embodiment of the invention.

FIG. 2 is a schematic of a rectifying module according to another embodiment of the invention.

FIG. 3 is a schematic of a rectifying module according to yet another embodiment of the invention.

FIG. 4-1 is a schematic of a rectifying module according to still another embodiment of the invention.

FIG. 4-2 is a schematic of a rectifying module according to still another embodiment of the invention.

FIG. 5-1 is a schematic of a rectifying module according to another embodiment of the invention.

FIG. 5-2 is a schematic of a rectifying module according to another embodiment of the invention.

FIG. 6 is a schematic of a rectifying module according to another embodiment of the invention.

FIG. 7 is a schematic of a rectifying module according to another embodiment of the invention.

FIG. 8-1 is a schematic of a rectifying module according to another embodiment of the invention.

FIG. 8-2 is a schematic of a rectifying module according to another embodiment of the invention.

FIG. 9 is a schematic of a generating device according to an embodiment of the invention.

FIG. 10 is a schematic of a generating device according to another embodiment of the invention.

FIG. 11 is a schematic enlarged partial view of a generating device according to an embodiment of the invention.

FIG. 12 is a schematic enlarged partial view of a generating device according to another embodiment of the invention.

FIG. 13 is a schematic of a generating device according to an embodiment of the invention.

FIG. 14 is a schematic enlarged partial view of a generating device according to an embodiment of the invention.

FIG. 15 is a schematic enlarged partial view of a generating device according to another embodiment of the invention.

FIG. 16-1 is a schematic of a generating device according to an embodiment of the invention.

FIG. 16-2 is a schematic of a generating device according to an embodiment of the invention.

FIG. 17-1 is a schematic of a generating device according to another embodiment of the invention.

FIG. 17-2 is a schematic of a generating device according to another embodiment of the invention.

FIG. 18 is a schematic of a generating device according to yet another embodiment of the invention.

FIG. 19 is a schematic enlarged partial view of a generating device according to an embodiment of the invention.

FIG. 20 is a schematic enlarged partial view of a generating device according to another embodiment of the invention.

FIG. 21 is a schematic of a generating device according to an embodiment of the invention.

FIG. 22 is a schematic enlarged partial view of a generating device according to an embodiment of the invention.

FIG. 23 is a schematic enlarged partial view of a generating device according to another embodiment of the invention.

FIG. 24-1 is a schematic of a generating device according to an embodiment of the invention.

FIG. 24-2 is a schematic of a generating device according to an embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations there of herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and in direct facing, and “adjacent to” and variations thereof herein are used broadly and encompass directly and indirectly “adjacent to”. Therefore, the description of “A” component facing “B” component herein may contain the situations that “A” component directly facing “B” component or one or more additional components are between “A” component and “B” component. Also, the description of “A” component “adjacent to” “B” component herein may contain the situations that “A” component is directly “adjacent to ” “B” component or one or more additional components are between “A” component and “B” component. Accordingly, the drawings and descriptions will be regarded as illustrative in nature and not as restrictive.

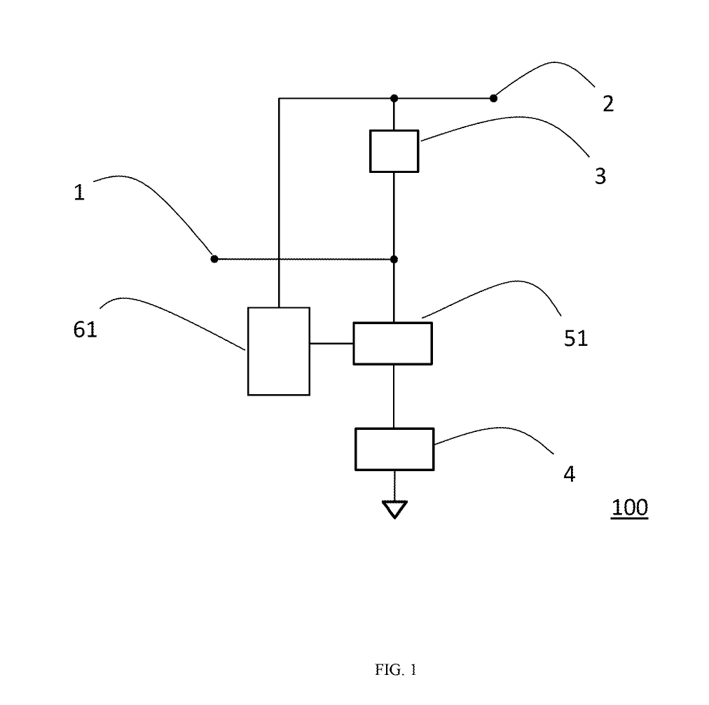

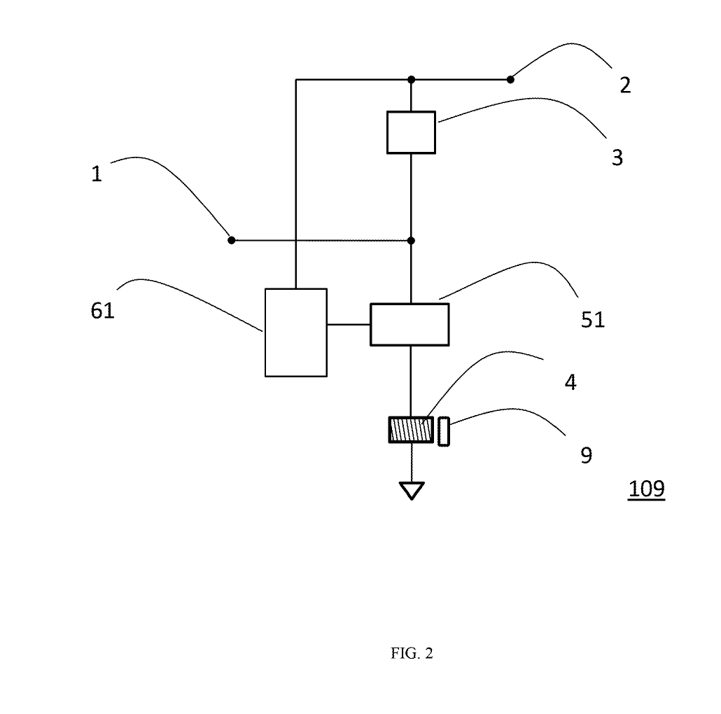

FIG. 1 is a schematic view of a rectifying module 100 according to an embodiment of the invention. Referring to FIG. 1, the rectifying module 100 of the embodiment includes an input end 1, a load end 2, a one way conduction element 3, an electricity storage device 4, a first switch 51, and a first control circuit 61. The one way conduction element 3 is electrically connected between the input end 1 and the load end 2 for that the electric charge pass from the input end 1 to the load end 2 when the voltage of the input end 1 is larger than the voltage of the load end 2. The electricity storage device 4 is used to store electricity energy temporarily. The first switch 51 is electrically connected between the input end 1 and the electricity storage device 4. The first control circuit 61 is electrically connected to the load end 2 and is used to enable the first switch 51 when the voltage of the load end 2 is larger than a predetermined value.

Within the operating range, the resistance of the one way conduction element 3 between its two electrodes (positive and negative electrode) is almost zero when forward bias, and the resistance of the one way conduction element 3 is huge when reverse bias. That's the current could pass the one way conduction element 3 in one direction. The one way conduction element 3 is, for example, diode, Schottky diode, Silicon Controlled Rectifier, Gate Turn-Off thyristor etc., but the invention is not limited thereto.

The first control circuit 61 enable the first switch 51 when the voltage of the load end 2 is larger than a predetermined value. In the invention, the circuit of the first control circuit 61 may be derived from over voltage protection circuit, or voltage stabilization circuit. For example, one may parallel add a Zener diode and a resistance, or parallel add two divider resistances, or other more complicated circuit between the load end 2 and ground, and the invention is not limited thereto.

The first switch 51 may be a controllable switch, for example, a transistor or a switch circuit composed with several elements. Transistor may be, for example, Unijunction Transistor, Bipolar Junction Transistor, Field effect transistor, Insulated Gate Bipolar Transistor, Programmable Unijunction Transistor, Junction Field Effect Transistor, Metal Oxide Semiconductor FET, and the invention is not limited thereto. The switch circuit may be, for example, an ideal diode no. LTC®4411 or no. LTC®4413 of Linear Technology Corporation. The invention is not limited thereto.

In the embodiment of the rectifying module 100, the electricity storage device 4 is a first coil, for example, an electromagnet, or a solenoid for providing magnetic field for usage when the first coil is electrify.

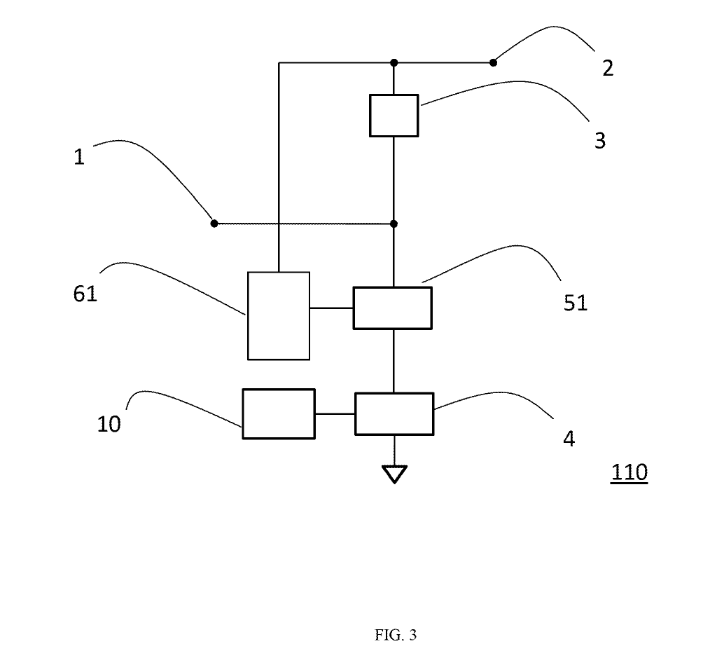

FIG. 2 is a schematic view of a rectifying module 109 according to another embodiment of the invention. The rectifying module 109 is similar to rectifying module 100, the same number represented the same element, and the description of the same element will not give unnecessary details. Referring to FIG. 2, the electricity storage device 4 of the rectifying module 109 of the embodiment is a first coil. The magnetic field of the electrified first coil interacts with a magnetic field of a permanent magnet 9 or a second coil (figure not show). The first coil and the permanent magnet 9 or the second coil may be the element of a relay, electromagnetic switch, solenoid valve, a motor, a linear motor or other device (figure not show) that transforms the electric energy to mechanical energy for usage.

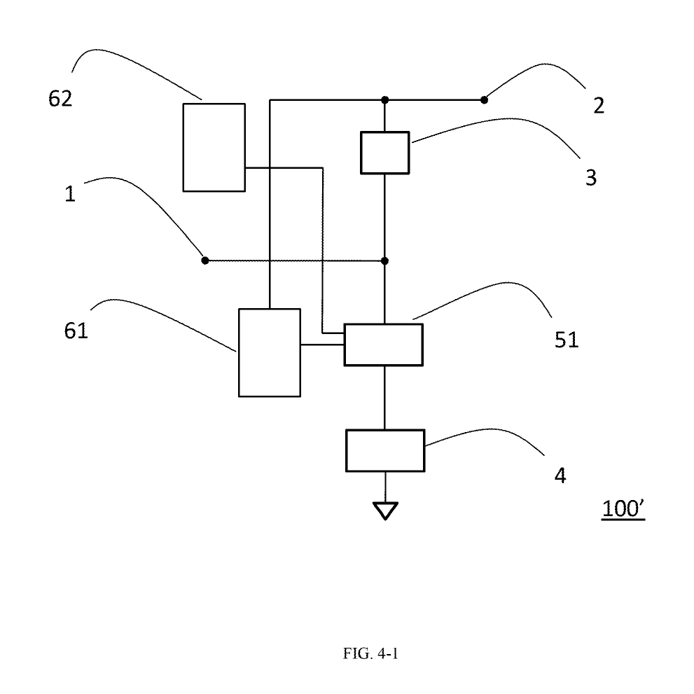

FIG. 3 is a schematic view of a rectifying module 110 according to another embodiment of the invention. The rectifying module 110 is similar to rectifying module 100, the same number represented the same element, and the description of the same element will not give unnecessary details. Referring to FIG. 3, the rectifying module 110 further includes an electric device 10. The electric device 10 is a device powered with electric energy and transforms the electric energy to mechanical energy to drive other device. The electric device 10 follows the principle of the magnetic effect of electric current, that an electrified coil will produce magnetic field. The magnetic field of electrified electric device 10 interacts with the other magnetic field of a permanent magnet or other coil to produce attractive force or repulsive force, that's change the electric energy to mechanical energy. The electric device 10 of the invention doesn't limit to traditional motor. A electric device 10 is a device following the principle of the magnetic effect of electric current, producing a magnetic field by a coil, transforming the electric energy to mechanical energy, and suitable for the invention after an appropriate modification. For example, electric device 10 may be a supersonic motor, a linear motor, a stepper motor, solenoid valve, servomotor, electric pump, compressor, or other device operating with a relay, an electromagnetic switch, a solenoid valve, electric pump or motor, to control the high pressure gas, high pressure liquid, spring, or other potential energy to produce the mechanical energy output, such as electric oil cylinder, electric pneumatic cylinder, hydraulic motor, or air motor.

In the embodiment of the rectifying module 110, the electricity storage device 4 is a coil, such as a inductance, or a solenoid for storing electricity energy temporarily and supplying electricity to electric device 10.

In the embodiment of the rectifying module 110, the electricity storage device 4 is a capacitor, such as common capacitor or Electric double-layer capacitors(Supercapacitor) for storing electricity energy temporarily and supplying electricity to electric device 10.

In the embodiment of the rectifying module 110, the electricity storage device 4 is a rechargeable battery, for example, a rechargeable chemical battery, a mechanical battery, a superconductor battery, or other suitable storage device for storing electricity energy temporarily and supplying electricity to electric device 10. The rechargeable chemical battery may be, for example, a lithium battery, a lithium ion battery, a lead-acid battery, or a nickel-metal hydride battery. The mechanical battery may be, for example, a flywheel battery. The invention is not limited thereto.

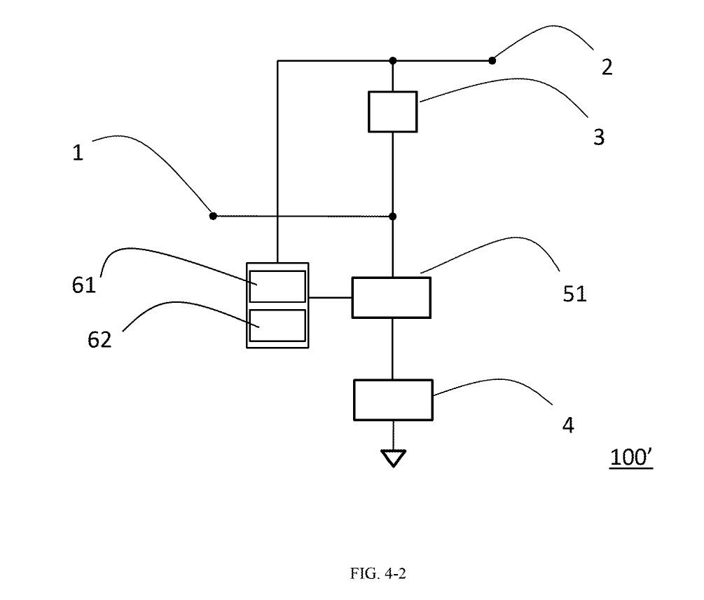

FIG. 4-1 is a schematic view of a rectifying module 100′ according to another embodiment of the invention. The rectifying module 100′ is similar to rectifying module 100, the same number represented the same element, and the description of the same element will not give unnecessary details. Referring to FIG. 4-1, rectifying module 100′ further includes a second control circuit 62 used to switch on and off the first switch 51 repeatedly for rectifying. For example, in a full-wave rectification, the one way conduction element 3 performs the positive half wave rectification, and the second control circuit 62 switches on and off the first switch 51 repeatedly to perform the negative half wave rectification. The first control circuit 61 and the second control circuit 62 are apart as showing in FIG. 4-1, but the invention is not limited thereto. Actually, the first control circuit 61 and the second control circuit 62 may be combined, for example, in one circuit board or in one integrated circuit chip. The invention is not limited the space disposing of the first control circuit 61 and the second control circuit 62. Referring to FIG. 4-2, the first control circuit 61 and the second control circuit 62 is integrated in one device.

In another embodiment of the invention, rectifying module 100′ is similar to the rectifying module 109, the electricity storage device 4 of the rectifying module 100′ is a first coil. The magnetic field of the electrified first coil interacts with a magnetic field of a permanent magnet or a second coil (figure not show).

In another embodiment of the invention, rectifying module 100′ is similar to the rectifying module 110, the rectifying module 100′ further includes an electric device(figure not show). The electricity storage device 4 is a capacitor, a coil or a battery used to power the electric device.

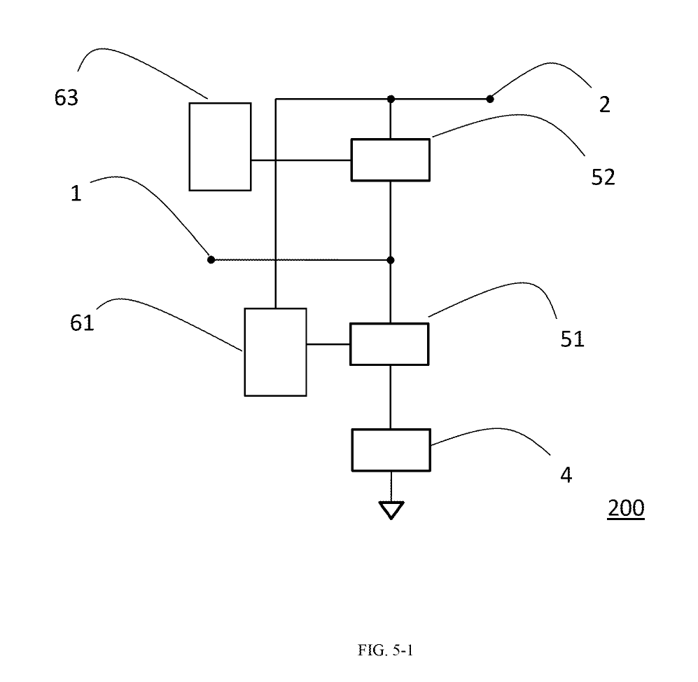

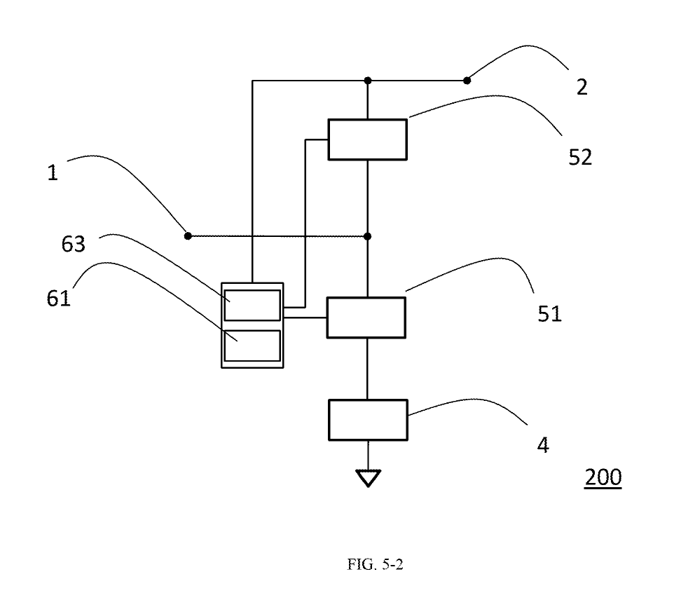

FIG. 5-1 is a schematic view of a rectifying module 200 according to another embodiment of the invention. Referring to FIG. 5-1, the a rectifying module 200 of the embodiment includes an input end 1, a load end 2, an electricity storage device 4, a first switch 51, a second switch 52, a first control circuit 61, and a second control circuit 62. The electricity storage device 4 is used to store electricity energy temporarily. The first switch 51 is electrically connected between the input end 1 and the electricity storage device 4. The second switch 52 is electrically connected between the input end 1 and the load end 2. The first control circuit 61 is electrically connected to the load end 2 and is used to enable the first switch 51 when the voltage of the load end 2 is larger than a predetermined value. The second control circuit 63 is used to switch on and off the second switch 52 repeatedly for rectifying. The second switch 52 may be a controllable switch, for example, a transistor or a switch circuit composed with several elements. Transistor may be, for example, Unijunction Transistor, Bipolar Junction Transistor, Field effect transistor, Insulated Gate Bipolar Transistor, Programmable Unijunction Transistor, Junction Field Effect Transistor, Metal Oxide Semiconductor FET, and the invention is not limited thereto. The switch circuit may be, for example, an ideal diode no. LTC®4411 or no. LTC®4413 of Linear Technology Corporation. The invention is not limited thereto. The first control circuit 61 and the second control circuit 63 are apart as showing in FIG. 5-1, but the invention is not limited thereto. Actually, the first control circuit 61 and the second control circuit 63 may be combined, for example, in one circuit board or in one integrated circuit chip. The invention is not limited the space disposing of the first control circuit 61 and the second control circuit 63. Referring to FIG. 5-2, the first control circuit 61 and the second control circuit 63 is integrated in one device.

FIG. 6 is a schematic view of a rectifying module 209 according to another embodiment of the invention. The rectifying module 209 is similar to rectifying module 200, the same number represented the same element, and the description of the same element will not give unnecessary details. Referring to FIG. 6, the electricity storage device 4 of the rectifying module 209 of the embodiment is a first coil. The magnetic field of the electrified first coil interacts with a magnetic field of a permanent magnet 9 or a second coil (figure not show). The first coil and the permanent magnet 9 or the second coil may be the element of a relay, an electromagnetic switch, a solenoid valve, a motor, a linear motor or other device (figure not show) that transforms the electric energy to mechanical energy for usage.

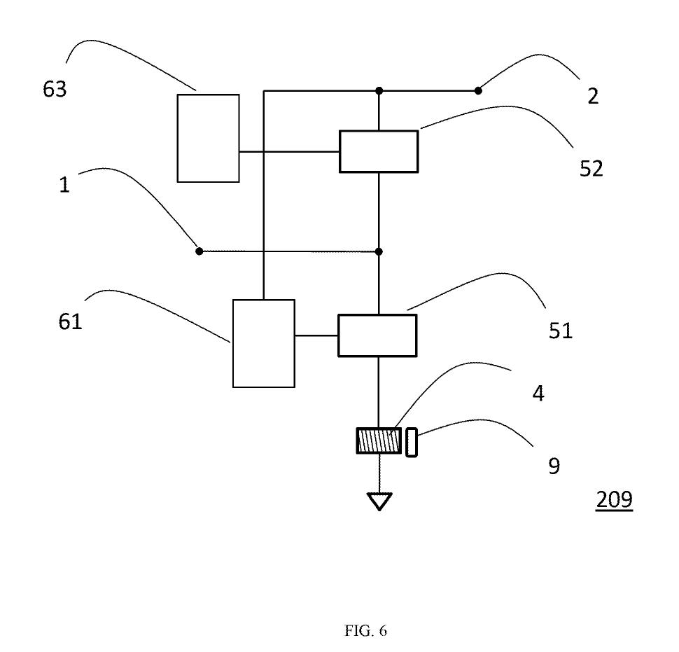

FIG. 7 is a schematic view of a rectifying module 210 according to another embodiment of the invention. The rectifying module 210 is similar to rectifying module 200, the same number represented the same element, and the description of the same element will not give unnecessary details. Referring to FIG. 7, the rectifying module 210 further includes an electric device 10. The electric device 10 is a device powered with electric energy and transforms the electric energy to mechanical energy to drive other device.

In the embodiment of the rectifying module 210, the electricity storage device 4 is a coil, such as a inductance, or a solenoid for storing electricity energy temporarily and supplying electricity to electric device 10.

In the embodiment of the rectifying module 210, the electricity storage device 4 is a capacitor, such as common capacitor or Electric double-layer capacitors(Supercapacitor) for storing electricity energy temporarily and supplying electricity to electric device 10.

In the embodiment of the rectifying module 210, the electricity storage device 4 is a rechargeable battery, for example, a rechargeable chemical battery, a mechanical battery, a superconductor battery, or other suitable storage device for storing electricity energy temporarily and supplying electricity to electric device 10. The rechargeable chemical battery may be, for example, a lithium battery, a lithium ion battery, a lead-acid battery, or a nickel-metal hydride battery. The mechanical battery may be, for example, a flywheel battery. The invention is not limited thereto. The first control circuit 61 and the second control circuit 63 are apart as showing in FIG. 6, and FIG. 7, but the invention is not limited thereto. Actually, the first control circuit 61 and the second control circuit 63 may be combined, for example, in one circuit board or in one integrated circuit chip. The invention is not limited the space disposing of the first control circuit 61 and the second control circuit 63.

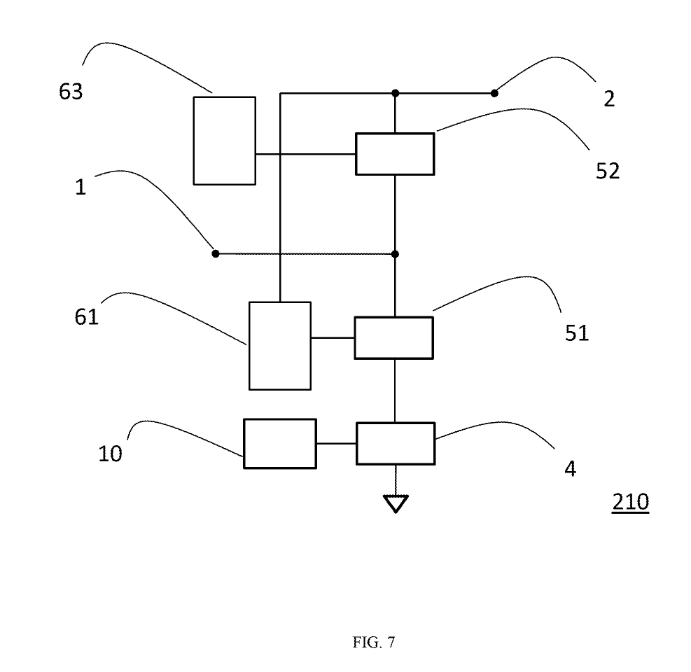

FIG. 8-1 is a schematic view of a rectifying module 200′ according to another embodiment of the invention. The rectifying module 200′ is similar to rectifying module 200, the same number represented the same element, and the description of the same element will not give unnecessary details. Referring to FIG. 8-1, the second control circuit 63′ of rectifying module 200′ is electrically connected to the first switch 51 to switch on and off the first switch 51 repeatedly for rectifying. For example, in a full-wave rectification, the second control circuit 63′ controls the second switch 52 to perform the positive half wave rectification, and the second control circuit 63′ switches on and off the first switch 51 repeatedly to perform the negative half wave rectification. The first control circuit 61 and the second control circuit 63′ are apart as showing in FIG. 8-1, but the invention is not limited thereto. Actually, the first control circuit 61 and the second control circuit 63′ may be combined, for example, in one circuit board or in one integrated circuit chip. The invention is not limited the space disposing of the first control circuit 61 and the second control circuit 63′. Referring to FIG. 8-2, the first control circuit 61 and the second control circuit 63′ is integrated in one device.

In another embodiment of the invention, rectifying module 200′ is similar to the rectifying module 209, the electricity storage device 4 of the rectifying module 200′ is a first coil. The magnetic field of the electrified first coil interacts with a magnetic field of a permanent magnet or a second coil (figure not show).

In another embodiment of the invention, rectifying module 200′ is similar to the rectifying module 210, the rectifying module 200′ further includes an electric device(figure not show). The electricity storage device 4 is a capacitor, a coil or a battery used to power the electric device.

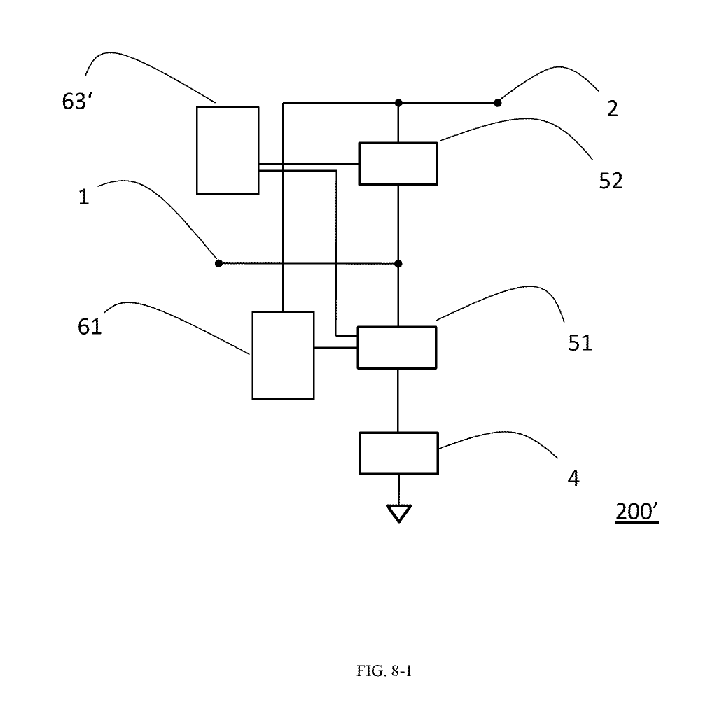

FIG. 9 is a schematic view of a generating device 1000 according to an embodiment of the invention. Referring to FIG. 9, the generating device 1000 of the embodiment includes a generator 7, a first battery 8, and a rectifying module 100. The rectifying module 100 includes an input end 1, a load end 2, a one way conduction element 3, an electricity storage device 4, a first switch 51, and a first control circuit 61. The input end 1 is electrically connected the generator 7. The load end 2 is electrically connected the first battery 8. The one way conduction element 3 is electrically connected between the input end 1 and the load end 2 for that the electric charge pass from the input end 1 to the load end 2 when the voltage of the input end 1 is larger than the voltage of the load end 2. The electricity storage device 4 is used to store electricity energy temporarily. The first switch 51 is electrically connected between the input end 1 and the electricity storage device 4. The first control circuit 61 is electrically connected to the load end 2 and used to enable the first switch 51 when the voltage of the load end 2 is larger than a predetermined value.

first battery 8 is a rechargeable battery, for example, a rechargeable chemical battery, a mechanical battery, a superconductor battery, or other suitable storage device for storing electricity energy temporarily and supplying electricity to electric device 10. The rechargeable chemical battery may be, for example, a lithium battery, a lithium ion battery, a lead-acid battery, or a nickel-metal hydride battery. The mechanical battery may be, for example, a flywheel battery. Other suitable storage device for storing electricity energy, such as Electric double-layer capacitors(Supercapacitor), that the invention is not limited thereto.

The generator 7 is an electric device transforming the mechanical energy to electric energy. The generator 7 is a device following the principle of electromagnetic induction by using all kind of motive force to change the distance between the coil and the magnet then change the magnetic flux within the coil to produce induced current, that's transforming the work by motive force to electric energy. The generator 7 of the invention is a device included but not limited to a traditional motor, following the principle of electromagnetic inductions, producing induced current by changing the distance between the coil and the magnet, that's changing the magnetic flux within the coil to produce induced current, and suitable for the invention after an appropriate modification.

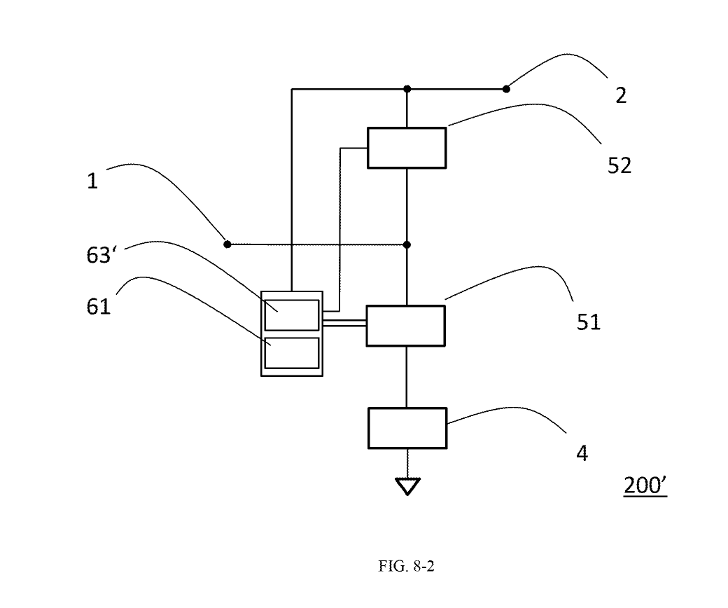

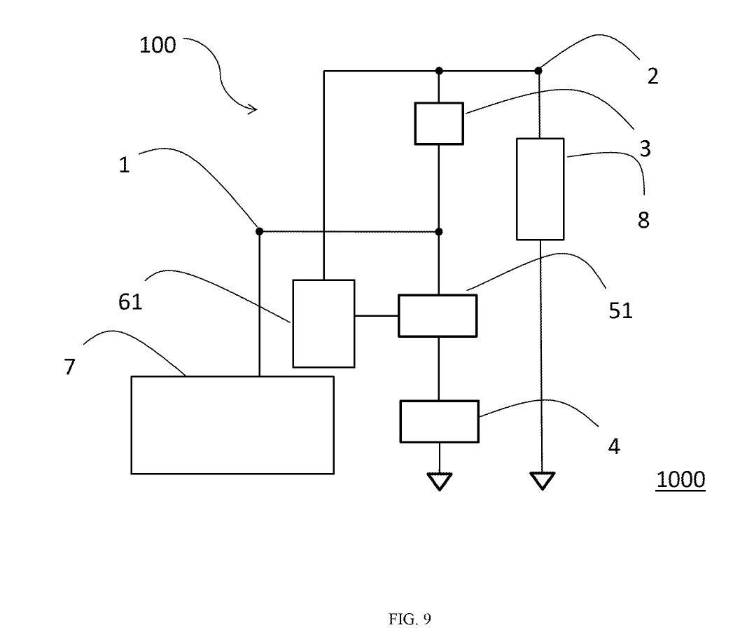

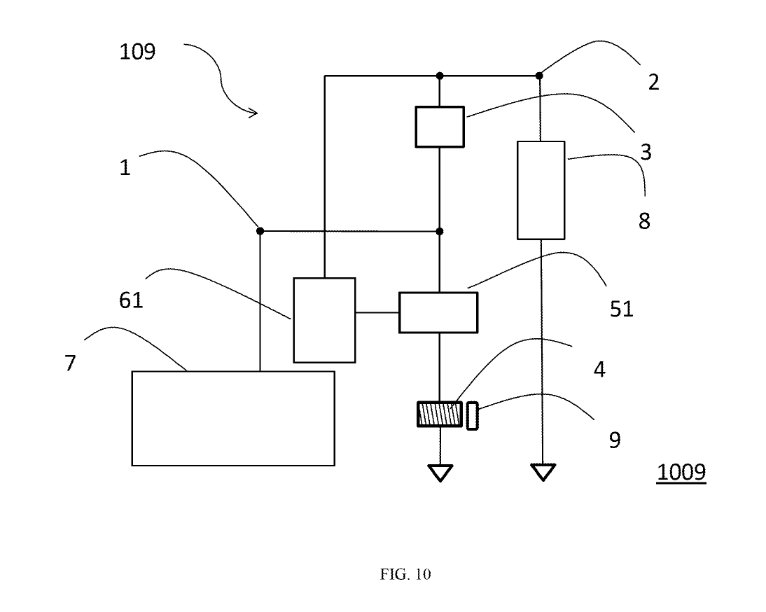

FIG. 10 is a schematic view of a generating device 1009 according to another embodiment of the invention. The generating device 1009 is similar to generating device 1000, the same number represented the same element, and the description of the same element will not give unnecessary details. Referring to FIG. 10, the electricity storage device 4 of the rectifying module 1009 of the embodiment is a first coil. The magnetic field of the electrified first coil interacts with a magnetic field of a permanent magnet 9 or a second coil (figure not show). The first coil and the permanent magnet 9 or the second coil may be the element of a relay, electromagnetic switch, solenoid valve, a motor, a linear motor or other device (figure not show) that transforms the electric energy to mechanical energy for usage.

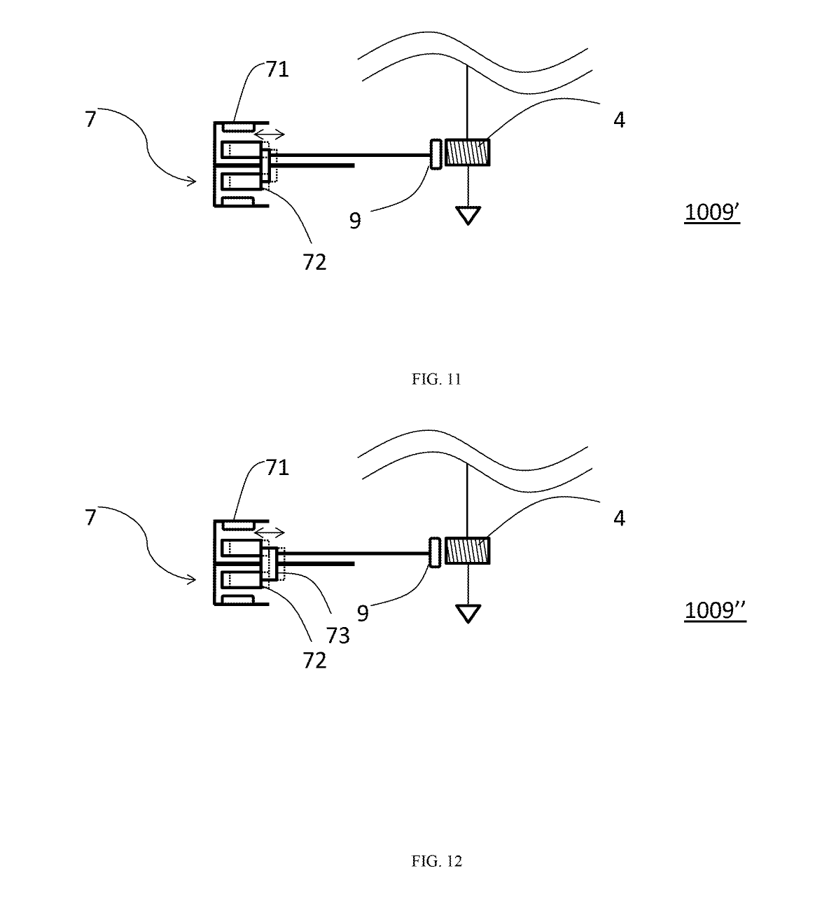

FIG. 11 is a schematic enlarged partial view of a generating device 1009′ according to an embodiment of the invention. The generator 7of the generating device 1009′ further includes a stator 72 and a rotor 71, and a distance between the stator 72 and the rotor 71 is changeable by the magnet field interactive between the first coil and the permanent magnet 9 or the second coil. For example, increase or decrease the distance between the stator 72 and the rotor 71. According to another embodiment of the invention, the distance between the stator 72 and the rotor 71 are able to increase by the magnet field interactive between the first coil and the permanent magnet 9 or the second coil. This arrangement may decrease the electric energy produced by the generator 7 when the rotation rate of the generator 7 is fixed. In detail, the output voltage of the generator 7 is larger when the rotation rate of the generator 7 is larger. When the output voltage of the generator 7 is larger than the predetermined input voltage value of the rectifying module 109, until the voltage of load end 2 is over the predetermined voltage value, the first control circuit 61 will enable the first switch 51. The electric energy will then be provided to the first circuit and enlarge the distance between the stator 72 and the rotor 71. The output of the generator 7 will reduce without change of the rotation rate of the generator 7. The waste of the exceeding electric energy will be reduced, and the heat of the generator 7 caused by the wasted exceeding energy will be reduced. FIG. 12 is a schematic enlarged partial view of a generating device 1009″ according to another embodiment of the invention. The generator 7of the generating device further includes a transmission device 73. The first coil and the permanent magnet 9 or the second coil may be the element in a relay, electromagnetic switch, solenoid valve, a motor, a linear motor or other device (figure not show) that drives the transmission device 73 to change the distance between the stator 72 and the rotor 71, for example, to increase the distance between the stator 72 and the rotor 71. The transmission device 73 may include but not limited to a worm, a gear wheel, a set of gear wheels, a guide pole, a guided groove, a valve, oil cylinder, pneumatic cylinder, a pump, a spring, a chain, a belt, a control line, or a reel (figure not show), etc. The transmission device 73 is machine used to change the distance between the stator 72 and the rotor 71, and the invention is not limited thereto. The generator as show in FIG. 11 and FIG. 12 is an external rotor generator, but the invention is not limited thereto. The generator 7 may be an inner rotor generator or other suitable generator. The generator 7 of the invention is a device included but not limited to a traditional motor, following the principle of electromagnetic inductions, producing induced current by changing the distance between the coil and the magnet, that's changing the magnetic flux within the coil to produce induced current, and suitable for the invention after an appropriate modification.

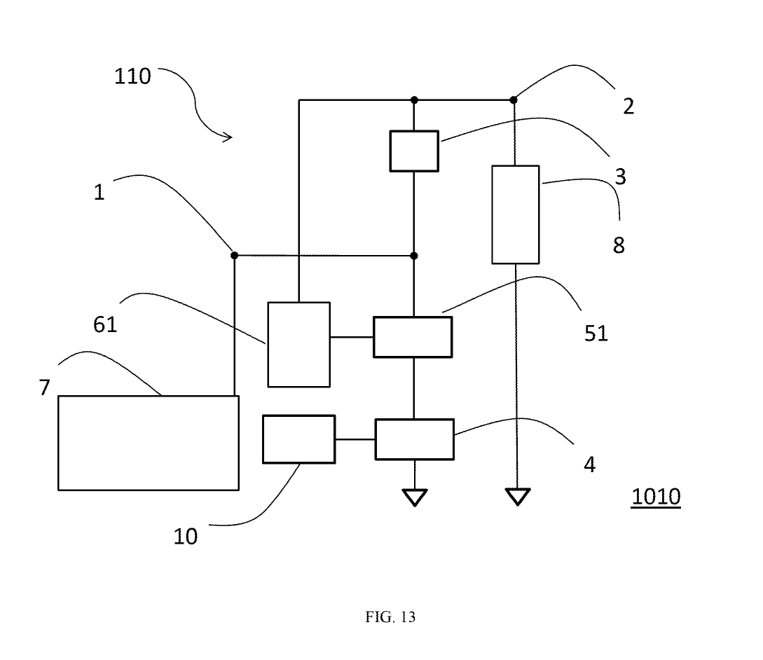

FIG. 13 is a schematic view of a generating device 1010 according to another embodiment of the invention. The generating device 1010 is similar to generating device 1000, the same number represented the same element, and the description of the same element will not give unnecessary details. Referring to FIG. 13, the generating device 1010 further includes an electric device 10. The electric device 10 is a device powered with electric energy and transforms the electric energy to mechanical energy to drive other device.

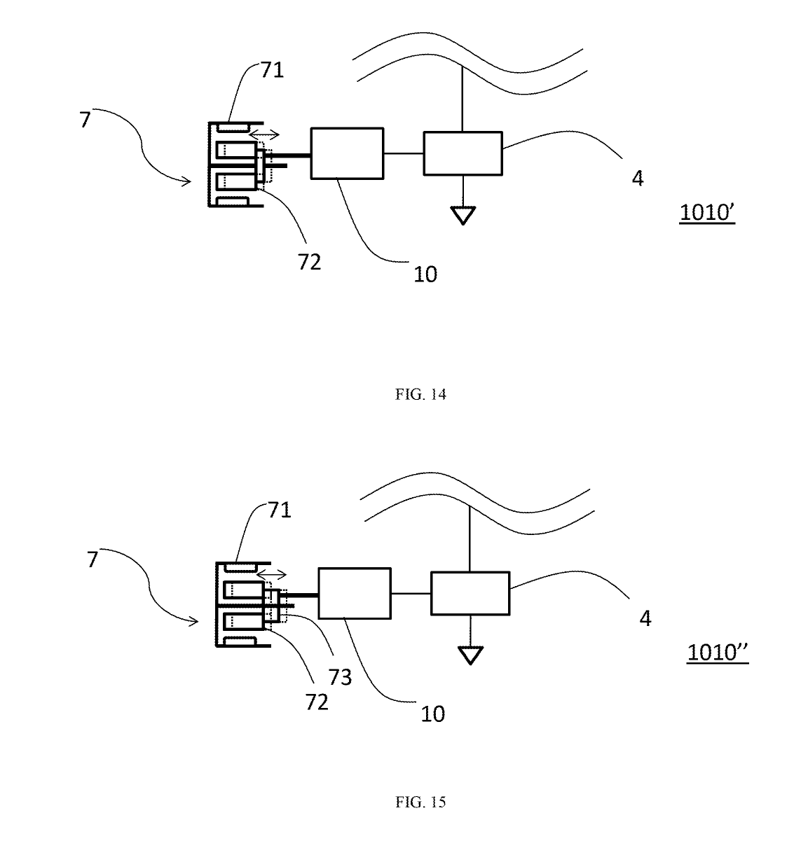

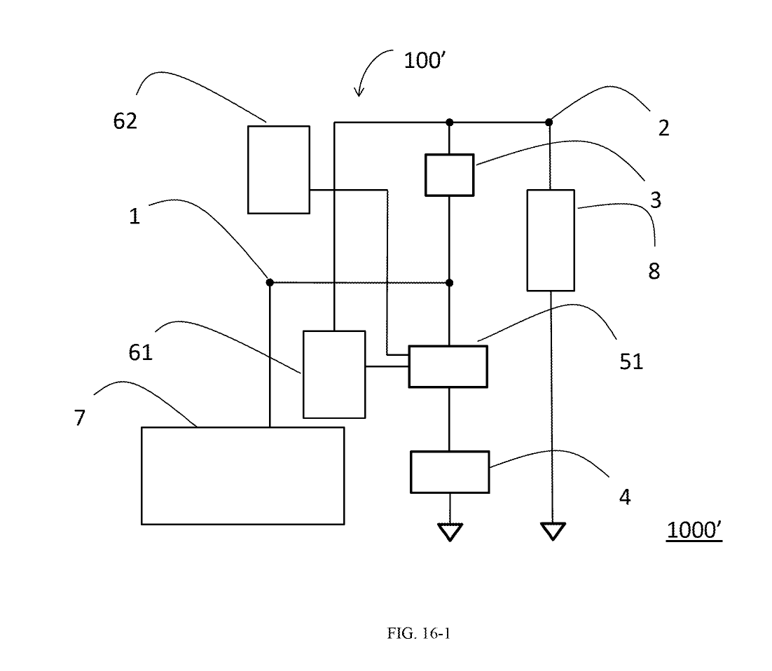

FIG. 14 is a schematic enlarged partial view of a generating device 1010′ according to an embodiment of the invention. The generator 7 of the generating device 1010′ further includes a stator 72 and a rotor 71. The electric device 10 is used to change a distance between the stator 72 and the rotor 71, for example, to increase the distance between the stator 72 and the rotator 71. FIG. 15 is a schematic enlarged partial view of a generating device 1010″ according to another embodiment of the invention. The generator 7 of the generating device further includes a transmission device 73. The electric device 10 is used to drive the transmission device 73 to change the distance between the stator 72 and the rotor 71, for example, to increase the distance between the stator 72 and the rotor 71. The transmission device 73 may include but not limited to a worm, a gear wheel, a set of gear wheels, a guide pole, a guided groove, a valve, oil cylinder, pneumatic cylinder, a pump, a spring, a chain, a belt, a control line, or a reel (figure not show), etc. The transmission device 73 is machine used to change the distance between the stator 72 and the rotor 71, and the invention is not limited thereto.

The generator as show in FIG. 14 and FIG. 15 is an external rotor generator, but the invention is not limited thereto. The generator 7 may be an inner rotor generator or other suitable generator. The generator 7 of the invention is a device included but not limited to a traditional motor, following the principle of electromagnetic inductions, producing induced current by changing the distance between the coil and the magnet, that's changing the magnetic flux within the coil to produce induced current, and suitable for the invention after an appropriate modification.

In the embodiments of the generating device 1010,1010′, or 1010″, the electricity storage device 4 is a coil, such as a inductance, or a solenoid for storing electricity energy temporarily and supplying electricity to electric device 10.

In the embodiments of the generating device 1010,1010′, or 1010″, the electricity storage device 4 is a capacitor, such as common capacitor or Electric double-layer capacitors(Supercapacitor) for storing electricity energy temporarily and supplying electricity to electric device 10.

In the embodiments of the generating device 1010,1010′, or 1010″, the electricity storage device 4 is a rechargeable battery, for example, a rechargeable chemical battery, a mechanical battery, a superconductor battery, or other suitable storage device for storing electricity energy temporarily and supplying electricity to electric device 10. The rechargeable chemical battery may be, for example, a lithium battery, a lithium ion battery, a lead-acid battery, or a nickel-metal hydride battery. The mechanical battery may be, for example, a flywheel battery. The invention is not limited thereto.

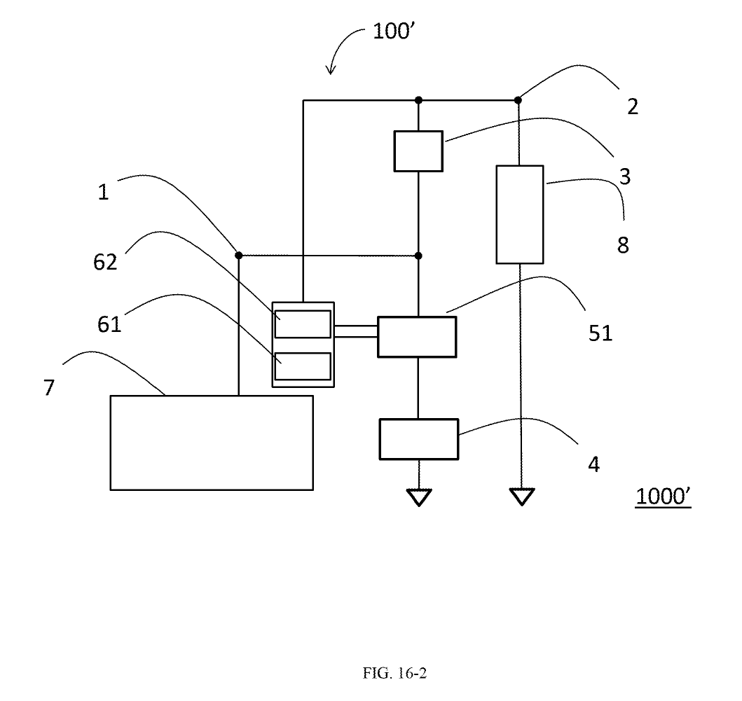

FIG. 16-1 is a schematic view of an generating device 1000′ according to another embodiment of the invention. The generating device 1000′ is similar to generating device 1000, the same number represented the same element, and the description of the same element will not give unnecessary details. Referring to FIG. 16-1, generating device 1000′ further includes a second control circuit 62 used to switch on and off the first switch 51 repeatedly for rectifying. The first control circuit 61 and the second control circuit 62 are apart as showing in FIG. 16-1, but the invention is not limited thereto. Actually, the first control circuit 61 and the second control circuit 62 may be combined, for example, in one circuit board or in one integrated circuit chip. The invention is not limited the space disposing of the first control circuit 61 and the second control circuit 62. Referring to FIG. 16-2, the first control circuit 61 and the second control circuit 62 is integrated in one device.

In another embodiment of the invention, the electricity storage device 4 of the generating device 1000′ is a first coil. The magnetic field of the electrified first coil interacts with a magnetic field of a permanent magnet or a second coil to change the distance between the stator 72 and the rotor 71 of the generator 7, for example, to increase the distance between the stator 72 and the rotor 71 (figure not show).

In another embodiment of the invention, generating device 1000′ further includes an electric device used to change the distance between the stator and the rotor (figure not show) of the generator 7, for example, to increase the distance between the stator and the rotor. The electricity storage device 4 is a capacitor, a coil or a battery used to power the electric device.

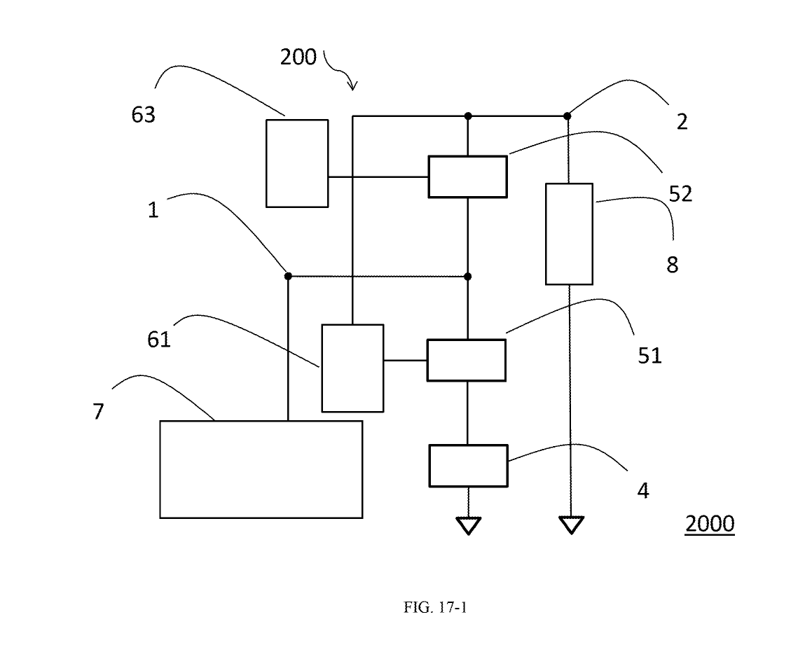

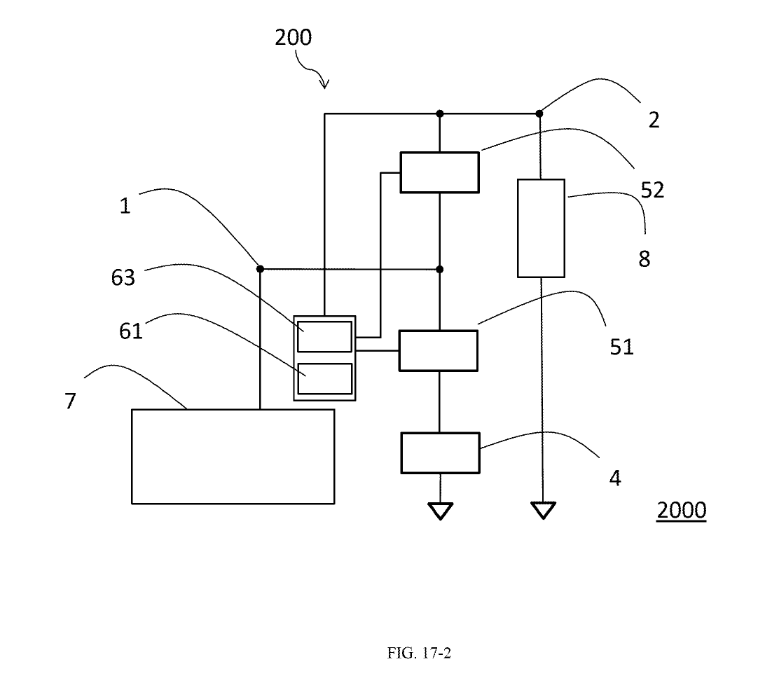

FIG. 17-1 is a schematic view of a generating device 2000 according to an embodiment of the invention. Referring to FIG. 17-1, the generating device 2000 of the embodiment includes a generator 7, a first battery 8, and a rectifying module 200. The rectifying module 200 includes an input end 1, a load end 2, an electricity storage device 4, a first switch 51, a second switch 52, a first control circuit 61, and a second control circuit 62. The input end 1 is electrically connected the generator 7. The load end 2 is electrically connected the first battery 8. The electricity storage device 4 is used to store electricity energy temporarily. The first switch 51 is electrically connected between the input end 1 and the electricity storage device 4. The second switch 52 is electrically connected between the input end 1 and the load end 2. The first control circuit 61 is electrically connected to the load end 2 and used to enable the first switch 51 when the voltage of the load end 2 is larger than a predetermined value. The second control circuit 63 is used to switch on and off the second switch 52 repeatedly for rectifying. The first control circuit 61 and the second control circuit 63 are apart as showing in FIG. 17-1, but the invention is not limited thereto. Actually, the first control circuit 61 and the second control circuit 63 may be combined, for example, in one circuit board or in one integrated circuit chip. The invention is not limited the space disposing of the first control circuit 61 and the second control circuit 63. Referring to FIG. 17-2, the first control circuit 61 and the second control circuit 62 is integrated in one device.

FIG. 18 is a schematic view of a generating device 2009 according to another embodiment of the invention. The generating device 2009 is similar to generating device 2000, the same number represented the same element, and the description of the same element will not give unnecessary details. Referring to FIG. 18, the electricity storage device 4 of the rectifying module 2009 of the embodiment is a first coil. The magnetic field of the electrified first coil interacts with a magnetic field of a permanent magnet 9 or a second coil (figure not show). The first coil and the permanent magnet 9 or the second coil may be the element of a relay, electromagnetic switch, solenoid valve, a motor, a linear motor or other device (figure not show) that transforms the electric energy to mechanical energy for usage. The first control circuit 61 and the second control circuit 63 are apart as showing in FIG. 18, but the invention is not limited thereto. Actually, the first control circuit 61 and the second control circuit 63 may be combined, for example, in one circuit board or in one integrated circuit chip. The invention is not limited the space disposing of the first control circuit 61 and the second control circuit 63.

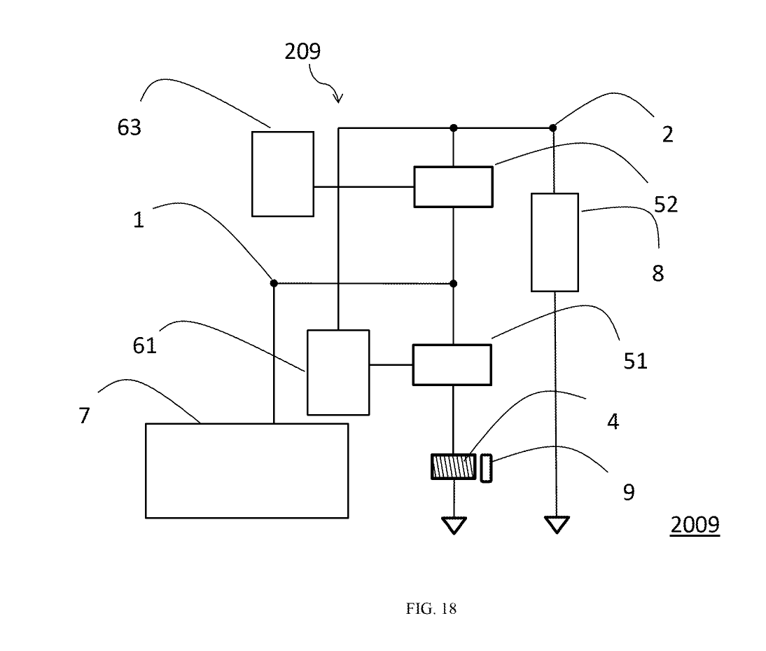

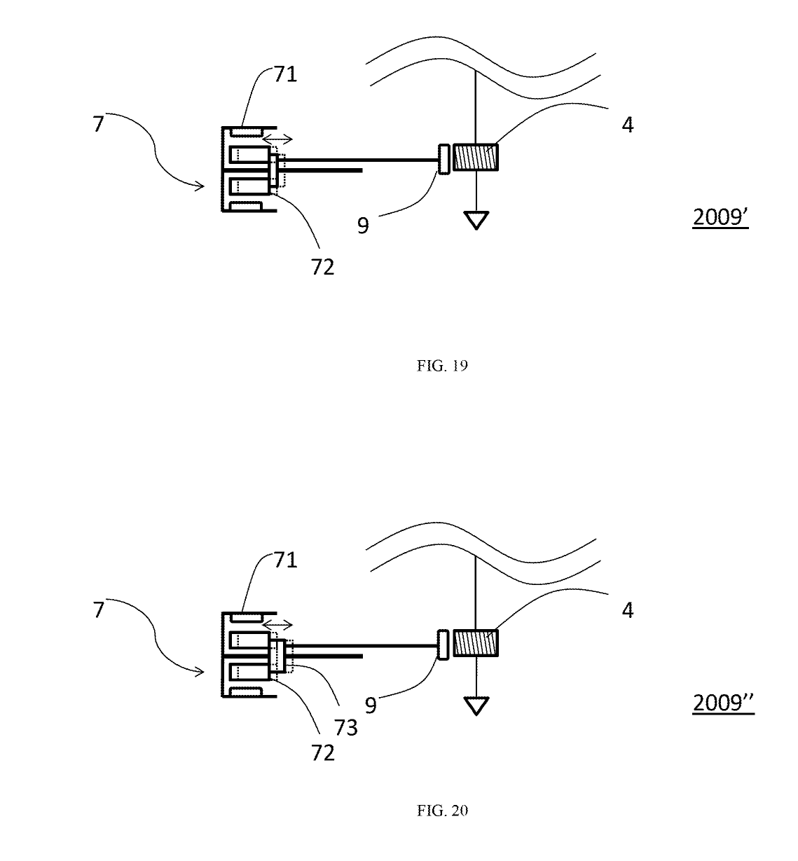

FIG. 19 is a schematic enlarged partial view of a generating device 2009′ according to an embodiment of the invention. The generator 7of the generating device 2009′ further includes a stator 72 and a rotor 71, and a distance between the stator 72 and the rotor 71 is changeable by the magnet field interactive between the first coil and the permanent magnet 9 or the second coil, for example, the distance between the stator 72 and the rotor 71 is able to increase by the magnet field interactive between the first coil and the permanent magnet 9 or the second coil. FIG. 20 is a schematic enlarged partial view of a generating device 2009″ according to another embodiment of the invention. The generator 7of the generating device further includes a transmission device 73. The first coil and the permanent magnet 9 or the second coil may be the element in a relay, electromagnetic switch, solenoid valve, a motor, a linear motor or other device (figure not show) that drives the transmission device 73 to change the distance between the stator 72 and the rotor 71, for example, to increase the distance between the stator 72 and the rotor 71. The transmission device 73 may include but not limited to a worm, a gear wheel, a set of gear wheels, a guide pole, a guided groove, a valve, oil cylinder, pneumatic cylinder, a pump, a spring, a chain, a belt, a control line, or a reel (figure not show), etc. The transmission device 73 is machine used to change the distance between the stator 72 and the rotor 71, and the invention is not limited thereto.

The generator as show in FIG. 19 and FIG. 20 is an external rotor generator, but the invention is not limited thereto. The generator 7 may be an inner rotor generator or other suitable generator. The generator 7 of the invention is a device included but not limited to a traditional motor, following the principle of electromagnetic inductions, producing induced current by changing the distance between the coil and the magnet, that's changing the magnetic flux within the coil to produce induced current, and suitable for the invention after an appropriate modification.

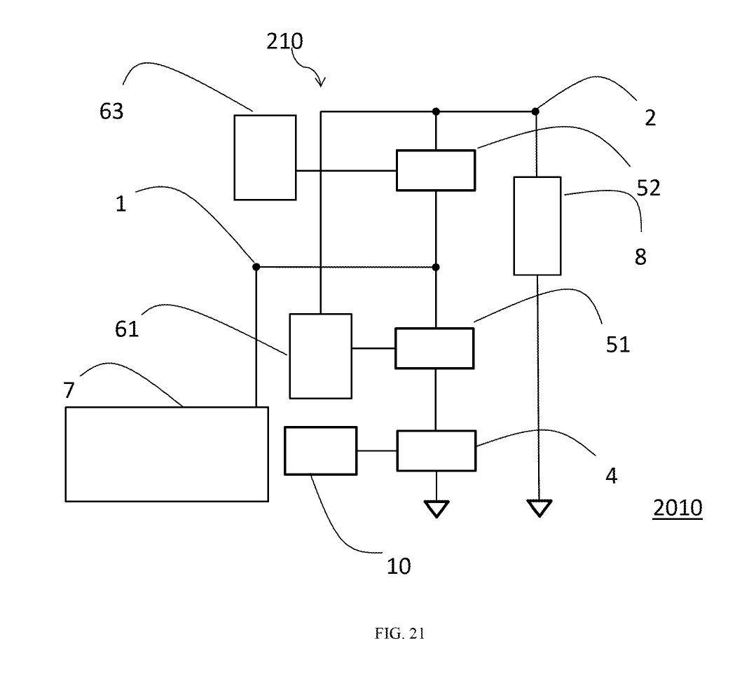

FIG. 21 is a schematic view of a generating device 2010 according to another embodiment of the invention. The generating device 2010 is similar to generating device 2000, the same number represented the same element, and the description of the same element will not give unnecessary details. Referring to FIG. 21, the generating device 2010 further includes an electric device 10. The electric device 10 is a device powered with electric energy and transforms the electric energy to mechanical energy to drive other device. The first control circuit 61 and the second control circuit 63 are apart as showing in FIG. 21, but the invention is not limited thereto. Actually, the first control circuit 61 and the second control circuit 63 may be combined, for example, in one circuit board or in one integrated circuit chip. The invention is not limited the space disposing of the first control circuit 61 and the second control circuit 63.

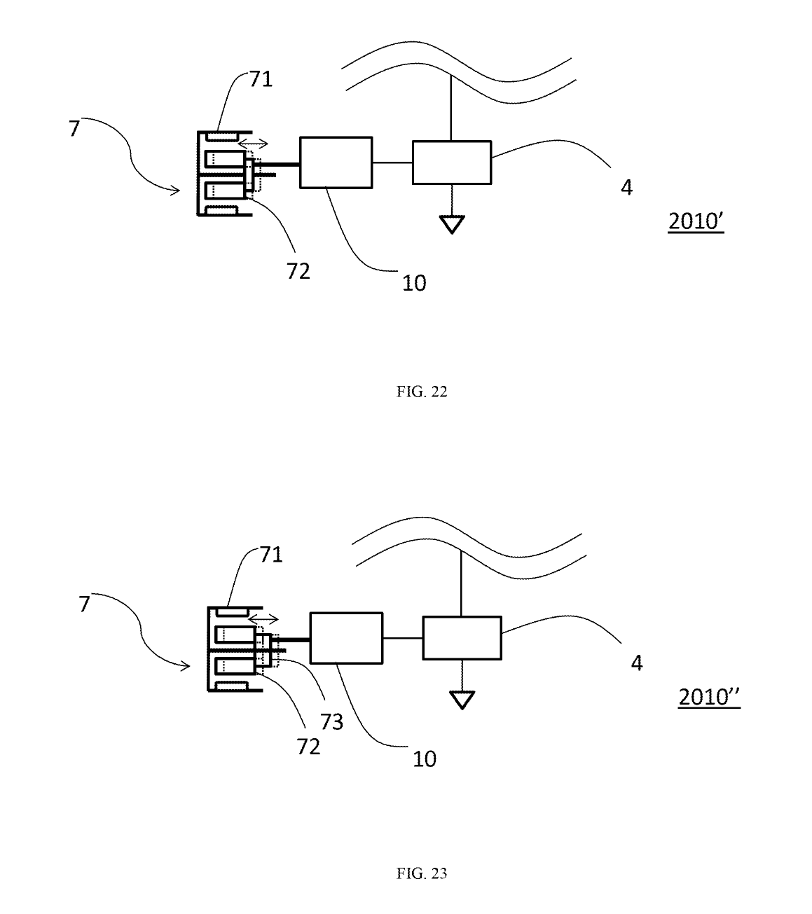

FIG. 22 is a schematic enlarged partial view of a generating device 2010′ according to an embodiment of the invention. The generator 7 of the generating device 2010′ further includes a stator 72 and a rotor 71. The electric device 10 is used to change a distance between the stator 72 and the rotor 71, for example, to increase the distance between the stator 72 and the rotor 71. FIG. 23 is a schematic enlarged partial view of a generating device 2010″ according to another embodiment of the invention. The generator 7 of the generating device further includes a transmission device 73. The electric device 10 is used to drive the transmission device 73 to change the distance between the stator 72 and the rotor 71, for example to increase the distance between the stator 72 and the rotor 71. The transmission device 73 may include but not limited to a worm, a gear wheel, a set of gear wheels, a guide pole, a guided groove, a valve, oil cylinder, pneumatic cylinder, a pump, a spring, a chain, a belt, a control line, or a reel (figure not show), etc. The transmission device 73 is machine used to change the distance between the stator 72 and the rotor 71, and the invention is not limited thereto.

The generator as show in FIG. 22 and FIG. 23 is an external rotor generator, but the invention is not limited thereto. The generator 7 may be an inner rotor generator or other suitable generator. The generator 7 of the invention is a device included but not limited to a traditional motor, following the principle of electromagnetic inductions, producing induced current by changing the distance between the coil and the magnet, that's changing the magnetic flux within the coil to produce induced current, and suitable for the invention after an appropriate modification.

In the embodiments of the generating device 2010, 2010′, or 2010″, the electricity storage device 4 is a coil, such as a inductance, or a solenoid for storing electricity energy temporarily and supplying electricity to electric device 10.

In the embodiments of the generating device 2010, 2010′, or 2010″, the electricity storage device 4 is a capacitor, such as common capacitor or Electric double-layer capacitors(Supercapacitor) for storing electricity energy temporarily and supplying electricity to electric device 10.

In the embodiments of the generating device 2010, 2010′, or 2010″, the electricity storage device 4 is a rechargeable battery, for example, a rechargeable chemical battery, a mechanical battery, a superconductor battery, or other suitable storage device for storing electricity energy temporarily and supplying electricity to electric device 10. The rechargeable chemical battery may be, for example, a lithium battery, a lithium ion battery, a lead-acid battery, or a nickel-metal hydride battery. The mechanical battery may be, for example, a flywheel battery. The invention is not limited thereto.

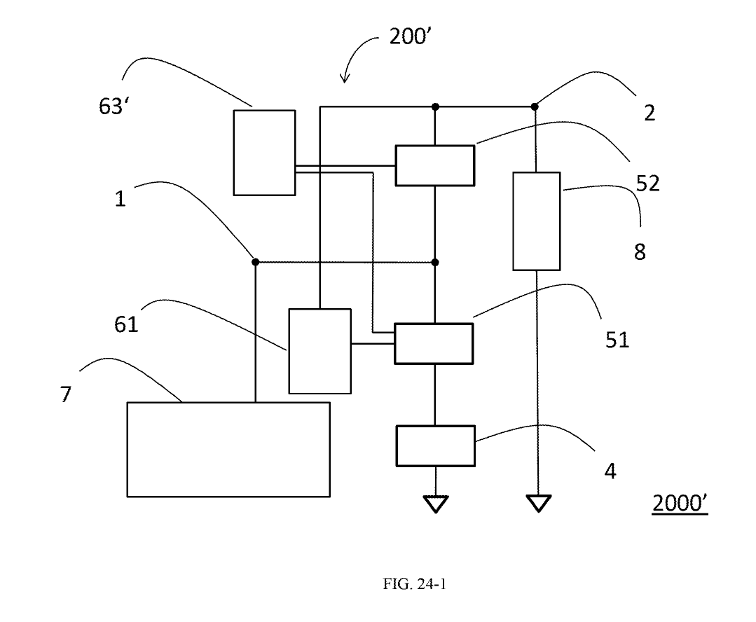

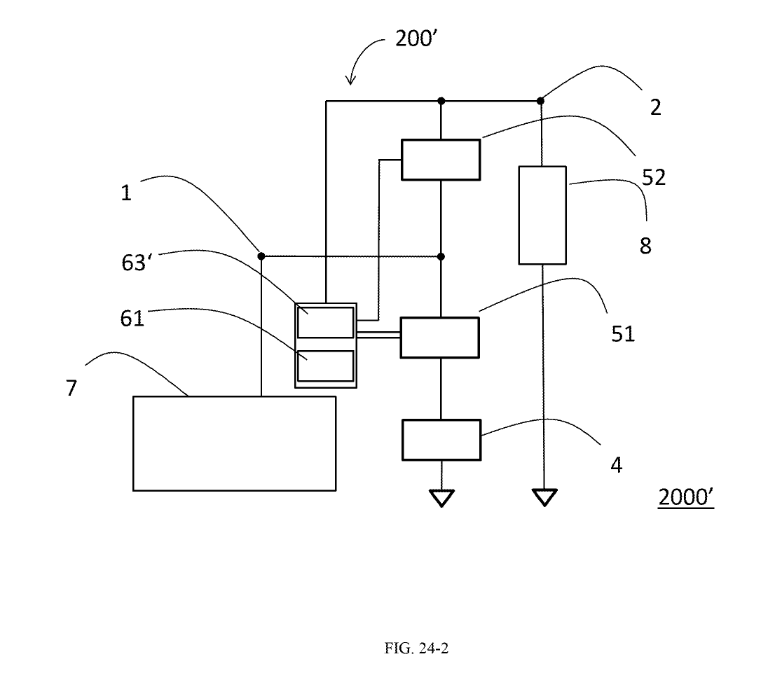

FIG. 24-1 is a schematic view of an generating device 2000′ according to another embodiment of the invention. The generating device 2000′ is similar to generating device 2000, the same number represented the same element, and the description of the same element will not give unnecessary details. Referring to FIG. 24-1, the second control circuit 63′ of the generating device 2000′ is electrically connected to the first switch 51 to switch on and off the first switch 51 repeatedly for rectifying. The first control circuit 61 and the second control circuit 63′ are apart as showing in FIG. 24-1, but the invention is not limited thereto. Actually, the first control circuit 61 and the second control circuit 63′ may be combined, for example, in one circuit board or in one integrated circuit chip. The invention is not limited the space disposing of the first control circuit 61 and the second control circuit 63′. Referring to FIG. 24-2, the first control circuit 61 and the second control circuit 63′ is integrated in one device.

In another embodiment of the invention, the electricity storage device 4 of the generating device 2000′ is a first coil. The magnetic field of the electrified first coil interacts with a magnetic field of a permanent magnet or a second coil to change the distance between the stator 72 and the rotor 71 of the generator 7, for example to increase the distance between the stator 72 and the rotor 71 (figure not show).

In another embodiment of the invention, generating device 2000′ further includes an electric device used to change the distance between the stator and the rotor (figure not show) of the generator 7, for example, to increase the distance between the stator and the rotor. The electricity storage device 4 is a capacitor, a coil or a battery used to power the electric device.

Based on the above, the rectifying module and the generating device of the embodiment of the invention has at least one of the following advantages. In the rectifying module according to the embodiment of the invention, the first control circuit is electrically connected to the load end and used to enable the first switch when the voltage of the load end is larger than a predetermined value. The excess electric energy could be transmitted to the electricity storage device for other utilization. The electric energy utilization rate is better, the waste heat of the rectifying module is reduced, and the durable of the rectifying module is better.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to be best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like dose not necessarily limit the claim scope to a specific embodiment, and the reference to particularly preferred exemplary embodiments of the invention dose not imply a limitation on the invention, and no such limitation is to be inferred. The invention is limited only by the spirit and scope of the appended claims. Moreover, these claims may refer to use “ first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A rectifying module, comprising:
an input end;
a load end;
a one way conduction element electrically connected between the input end and the load end for that the electric charge pass from the input end to the load end when the voltage of the input end is larger than the voltage of the load end;
an electricity storage device used to store electricity energy temporarily;
a first switch electrically connected between the input end and the electricity storage device; and
a first control circuit electrically connected to the load end and used to enable the first switch when the voltage of the load end is larger than a predetermined value.

2. The rectifying module as claimed in claim 1, wherein the electricity storage device is a first coil.

3. The rectifying module as claimed in claim 2, wherein the magnetic field of the first coil when electrified interacts with a magnetic field of a permanent magnet or a second coil.

4. The rectifying module as claimed in claim 1, further comprising an electric device wherein the electricity storage device is a capacitor, a coil or a battery used to power the electric device.

5. The rectifying module as claimed in claim 1, further comprising a second control circuit used to switch on and off the first switch repeatedly for rectifying.

6. A rectifying module, comprising:
an input end;
a load end;
an electricity storage device used to store electricity energy temporarily;
a first switch electrically connected between the input end and the electricity storage device;
a second switch electrically connected between the input end and the load end;
a first control circuit electrically connected to the load end and used to enable the first switch when the voltage of the load end is larger than a predetermined value; and
a second control circuit used to switch on and off the second switch repeatedly for rectifying.

7. The rectifying module as claimed in claim 6, wherein the electricity storage device is a first coil.

8. The rectifying module as claimed in claim 7, wherein the magnetic field of the first coil when electrified interacts with a magnetic field of a permanent magnet or a second coil.

9. The rectifying module as claimed in claim 6, further comprising an electric device wherein the electricity storage device is a capacitor, a coil or a battery used to power the electric device.

10. The rectifying module as claimed in claim 6, wherein the second control circuit is electrically connected to the first switch to switch on and off the first switch repeatedly for rectifying.

11. A generating device, comprising:
a generator;
a first battery; and
a rectifying module comprising:
an input end electrically connected the generator;
a load end electrically connected the first battery;
a one way conduction element electrically connected between the input end and the load end for that the electric charge pass from the input end to the load end when the voltage of the input end is larger than the voltage of the load end;
an electricity storage device used to store electricity energy temporarily;
a first switch electrically connected between the input end and the electricity storage device; and
a first control circuit electrically connected to the load end and used to enable the first switch when the voltage of the load end is larger than a predetermined value.

12. The generating device as claimed in claim 11, wherein the electricity storage device is a first coil.

13. The generating device as claimed in claim 12, wherein the magnetic field of the first coil when electrified interacts with a magnetic field of a permanent magnet or a second coil.

14. The generating device as claimed in claim 13, wherein the generator further comprises a stator and a rotor, and a distance between the stator and the rotor is changeable by the magnet field interactive between the first coil and the permanent magnet or the second coil.

15. The generating device as claimed in claim 13, wherein the generator further comprises a stator and a rotor, and a distance between the stator and the rotor is able to increase by the magnet field interactive between the first coil and the permanent magnet or the second coil.

16. The generating device as claimed in claim 11, further comprising an electric device, and the generator further comprising a stator and a rotor, wherein the electric device is used to change a distance between the stator and the rotor and the electricity storage device is used to power the electric device.

17. The generating device as claimed in claim 11, further comprising an electric device, and the generator further comprising a stator and a rotor, wherein the electric device is used to increase a distance between the stator and the rotor and the electricity storage device is used to power the electric device.

18. The generating device as claimed in claim 17, wherein the electricity storage device is a capacitor, a coil or a battery.

19. The generator device as claimed in claim 11, wherein the rectifying module further comprises a second control circuit used to switch on and off the first switch repeatedly for rectifying.

20. A generating device, comprising:
a generator;
a first battery; and
a rectifying module comprising:
an input end electrically connected the generator;
a load end electrically connected the first battery;
an electricity storage device used to store electricity energy temporarily;
a first switch electrically connected between the input end and the electricity storage device;
a second switch electrically connected between the input end and the load end;
a first control circuit electrically connected to the load end and used to enable the first switch when the voltage of the load end is larger than a predetermined value; and
a second control circuit used to switch on and off the second switch repeatedly for rectifying.

21. The generating device as claimed in claim 20, wherein the electricity storage device is a first coil.

22. The generating device as claimed in claim 21, wherein the magnetic field of the first coil when electrified interacts with a magnetic field of a permanent magnet or a second coil.

23. The generating device as claimed in claim 22, wherein the generator further comprises a stator and a rotor, and a distance between the stator and the rotor is changeable by the magnet field interactive between the first coil and the permanent magnet or the second coil.

24. The generating device as claimed in claim 22, wherein the generator further comprises a stator and a rotor, and a distance between the stator and the rotor is able to increase by the magnet field interactive between the first coil and the permanent magnet or the second coil.

25. The generating device as claimed in claim 20, further comprising an electric device, and the generator further comprising a stator and a rotor, wherein the electric device is used to change a distance between the stator and the rotor and the electricity storage device is used to power the electric device.

26. The generating device as claimed in claim 20, further comprising an electric device, and the generator further comprising a stator and a rotor, wherein the electric device is used to increase a distance between the stator and the rotor and the electricity storage device is used to power the electric device.

27. The generating device as claimed in claim 26, wherein the electricity storage device is a capacitor, a coil or a battery.

28. The generator device as claimed in claim 20, wherein the second control circuit is electrically connected to the first switch to switch on and off the first switch repeatedly for rectifying.
